(19) United States
(12) Patent Application Publication
(10) Pub. No.: US 2026/0169888 A1
(43) Pub. Date: Jun. 18, 2026

(54) EVALUATING A RESPONSE OF A WEBSITE TO SIMULATED USER ACTIONS USING ARTIFICIAL INTELLIGENCE

(71) Applicant: Maplebear Inc., San Francisco, CA (US)

(72) Inventors: Prithvishankar Srinivasan, Seattle, WA (US); Shishir Kumar Prasad, San Ramon, CA (US); Shih-Ting Lin, Santa Clara, CA (US); Aomin Wu, Scarsdale, NY (US)

(21) Appl. No.: 18/981,607

(22) Filed: Dec. 15, 2024

(51) Int. Cl. G06F 11/34; G06Q 30/0601

(52) U.S. Cl. CPC G06F 11/3457; G06Q 30/0633

(57) ABSTRACT

A website evaluation system generates a sequence of actions performed on a website based on actions performed by users of the website, in which the sequence of actions corresponds to a task. The system simulates performance of the sequence of actions on the website and receives a set of contextual information associated with the website and a response of the website to the sequence of actions. The system generates a prompt including the set of contextual information, information describing the sequence of actions, information describing the response of the website, and a request to evaluate the response to identify a set of problems with the website based on the set of contextual information and a set of objectives associated with the website. The system provides the prompt to a generative artificial intelligence model to obtain an output, extracts an evaluation of the response from the output, and stores the evaluation.

### BACKGROUND

Websites that are new or updated are typically evaluated manually or via user feedback for problems that may affect the ability of users to perform various functions on the websites, such as navigating them efficiently, finding relevant information, etc. Problems with websites may include design issues (e.g., confusing layouts, color combinations that make text difficult to read, etc.), poor functionality or content (e.g., irrelevant or duplicate search results), etc. However, the manual evaluation of websites is a time-consuming and labor-intensive process. Furthermore, since evaluating websites manually or via user feedback is subjective, the results may be inconsistent.

### SUMMARY

In accordance with one or more aspects of the disclosure, a website evaluation system evaluates a response of a website to simulated user actions using artificial intelligence. More specifically, a website evaluation system generates a sequence of actions performed on a website based on actions performed by one or more users of the website, in which the sequence of actions corresponds to a task performed by the user(s). The website evaluation system also simulates a performance of the sequence of actions on the website and receives a set of contextual information associated with the website and a response of the website to the sequence of actions. The website evaluation system then generates a prompt including the set of contextual information, information describing the sequence of actions, information describing the response of the website, and a request to evaluate the response to identify a set of problems with the website based on the set of contextual information and a set of objectives associated with the website. The website evaluation system provides the prompt to a generative artificial intelligence model to obtain an output, extracts an evaluation of the response from the output, and stores the evaluation. In one or more embodiments, the generative artificial intelligence model is tuned based on a set of website data for the website, while in other embodiments, the set of website data is included in the prompt. In some embodiments, the set of website data includes the set of objectives associated with the website, information describing a source associated with the website, or item data for one or more items available at one or more source locations operated by the source.

By simulating the performance of the sequence of actions and using the generative artificial intelligence model to evaluate the response of the website to the sequence of actions, the website evaluation system automates the process of evaluating the website for problems, making it much more efficient than manual evaluation. Furthermore, in contrast to the subjective process of evaluating websites manually or via user feedback, automating this process provides consistent results.

### BRIEF DESCRIPTION OF THE DRAWINGS

FIG. 1 illustrates an example system environment for an online system and a website evaluation system, in accordance with one or more embodiments.

FIG. 2 illustrates an example system architecture for an online system, in accordance with one or more embodiments.

FIG. 3 illustrates an example system architecture for a website evaluation system, in accordance with one or more embodiments.

FIG. 4 is a flowchart of a method for evaluating a response of a website to simulated user actions using artificial intelligence, in accordance with one or more embodiments.

FIG. 5 is a process flow diagram for evaluating a response of a website to simulated user actions using artificial intelligence, in accordance with one or more embodiments.

FIGS. 6A-6C illustrate examples of a screenshot describing a response of a website to a sequence of actions simulated on the website, in accordance with one or more embodiments.

### DETAILED DESCRIPTION

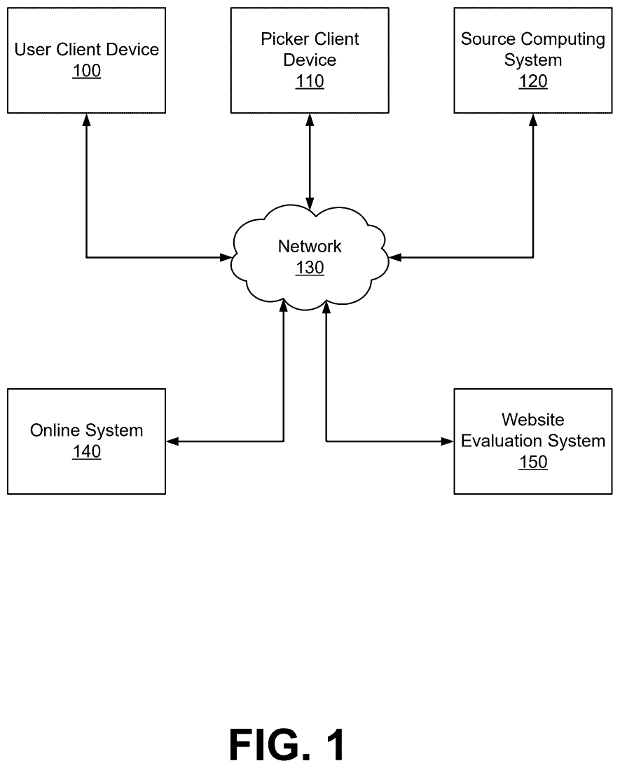

FIG. 1 illustrates an example system environment for an online system 140 and a website evaluation system 150, in accordance with one or more embodiments. The system environment illustrated in FIG. 1 includes a user client device 100, a picker client device 110, a source computing system 120, a network 130, an online system 140, and a website evaluation system 150. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

Furthermore, although one online system 140 is illustrated in FIG. 1, any number of online systems 140 may interact with the website evaluation system 150. As such, there may be more than one online system 140.

The user client device 100 is a client device through which a user may interact with the picker client device 110, the source computing system 120, or the online system 140. The user client device 100 may be a personal or mobile computing device, such as a smartphone, a tablet, a laptop computer, or a desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, refers to a good or a product that may be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more source locations from which the ordered items should be collected.

The user client device 100 presents an ordering interface to the user. The ordering interface is a user interface that the user may use to place an order with the online system 140. The ordering interface may be part of a client application operating on the user client device 100. The ordering interface allows the user to search for items that are available through the online system 140 and the user may select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the items should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 may be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source location. The picker client device 110 presents the items that are included in the user's order to the picker in a collection interface. The collection interface is a user interface that provides information to the picker identifying items to collect for a user's order and indicating the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source location, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker may use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may identify the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 provides instructions to a picker for delivering the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they may use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be a user client device 100 being operated by a user collecting items for themselves within the source location. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, a warehouse, or any other source location from which a picker may collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Furthermore, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, the online system 140, and the website evaluation system 150 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store source and the quantities of each of the groceries. The user's client device 100 transmits the user's order to the online system 140 and the online system 140 selects a picker to travel to the grocery store source location to collect the groceries ordered by the user. The online system 140 transmits an offer to the picker for the picker to service the order in exchange for consideration and, if the picker accepts the offer, the picker collects the groceries from the grocery store source location. Once the picker has collected the groceries ordered by the user, the picker delivers the groceries to a location transmitted to the picker client device 110 by the online system 140.

In some embodiments, the online system 140 allows users to perform additional or alternative types of functions. Examples of such types of functions include: connecting and communicating with other users, streaming videos, searching for information on the Internet, playing games with other users, etc. In such embodiments, the online system 140 may be a social networking system, a video streaming system, a search engine, an online gaming system, or any other suitable type of online system.

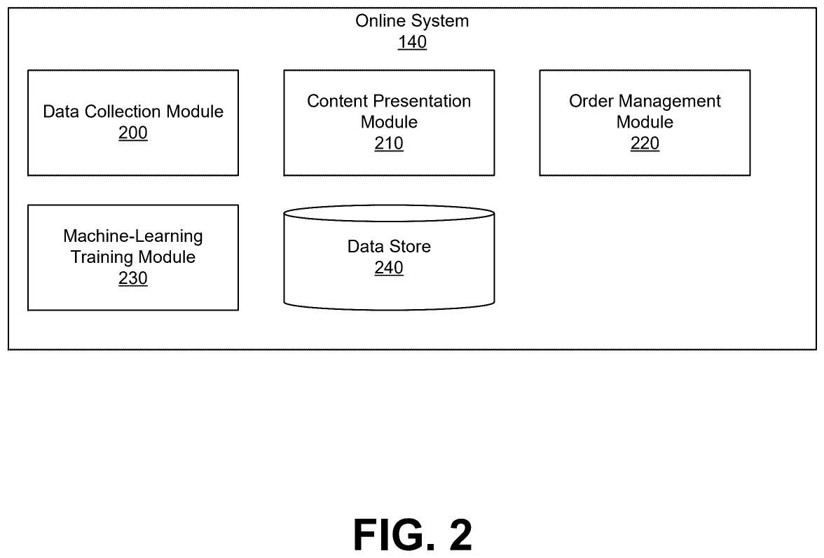

Users may interact with the online system 140 via a website associated with the online system 140. In some embodiments, users may interact with the online system 140 via other means, such as a digital platform, a software application, etc. associated with the online system 140. The online system 140 is described in further detail below with regards to FIG. 2.

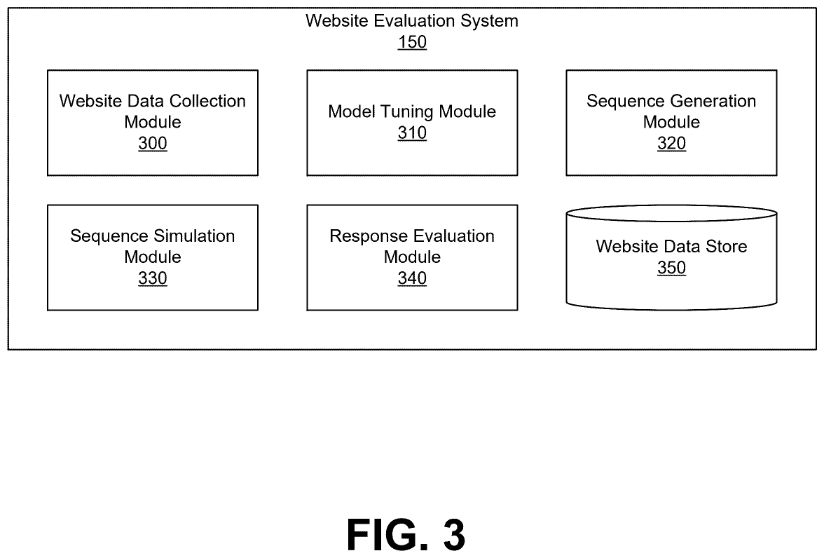

The website evaluation system 150 is a system that evaluates websites to identify problems with the websites. Problems with websites may include design issues (e.g., confusing layouts, color combinations that make text difficult to read, etc.), poor functionality (e.g., broken pages or links, slow loading time, etc.), poor content (e.g., irrelevant or duplicate search results, outdated content, low quality images or videos, etc.), incompatibility with mobile devices, etc. For example, the website evaluation system 150 may evaluate a website for the online system 140 to identify various problems, such as irrelevant or duplicate search results. The website evaluation system 150 may provide the results of its evaluation as a report or as a set of negative training examples that may be used to address any problems it identifies. In some embodiments, the website evaluation system 150 evaluates other types of digital platforms (e.g., digital games) or software applications (e.g., mobile applications) for problems. The website evaluation system 150 is described in further detail below with regards to FIG. 3.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

The data collection module 200 collects user data, which is information or data that describe characteristics of a user. User data may include a user's name, address, shopping preferences, favorite items, or stored payment instruments. User data also may include demographic information associated with a user (e.g., age, gender, geographical region, etc.) or household information associated with the user (e.g., a number of people in the user's household, whether the user's household includes children or pets, etc.). User data also may include information describing a type of user client device 100 (e.g., a mobile device) associated with a user. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for an item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular source location), the item data may include a time that the item was last found, a time that the item was last not found (a picker looked for the item but could not find it), the rate at which the item is found, or the popularity of the item. The data collection module 200 may collect item data from a source computing system 120, a picker client device 110, or a user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. In some embodiments, item categories may be broader in that the same item category may include item types that are related to a common theme, found in the same department, etc. For example, items such as apples, oranges, lettuce, and cucumbers may be included in a “produce” item category. As an additional example, items such as bread, pasta, and cookies that are gluten-free may be included in a “gluten-free” item category, while items such as tortilla chips and tofu that are non-GMO may be included in a “non-GMO” item category. Furthermore, in various embodiments, an item may be included in multiple item categories. For example, non-fat milk may be included in a “non-fat milk” item category, a “milk” item category, and a “dairy” item category. The item categories may be human-generated and human-populated with items. The item categories also may be generated automatically by the online system 140 (e.g., using a clustering algorithm).

The item data also may include a hierarchical taxonomy into which items available at a source location are organized, in which different levels of the hierarchical taxonomy provide different levels of specificity about items included in the levels. The data collection module 200 may receive the hierarchical taxonomy from a source that operates the source location or it may generate the hierarchical taxonomy from the item data. The data collection module 200 may generate the hierarchical taxonomy by applying a trained classification model to the item data to include different items in levels of the hierarchical taxonomy, such that specific items are associated with item categories corresponding to levels within the hierarchical taxonomy. The data collection module 200 may maintain the hierarchical taxonomy (e.g., as new item data is received, as the item data is updated, etc.).

A hierarchical taxonomy may identify an item category and associate one or more specific items with the item category. For example, if an item category identifies “milk,” a hierarchical taxonomy may associate identifiers of different milk items (e.g., milk having one or more different attributes) with the item category. Thus, the hierarchical taxonomy may maintain associations between an item category and specific items available at a source location matching the item category. Furthermore, different levels of the hierarchical taxonomy may identify items with differing levels of specificity based on any suitable attribute or combination of attributes of the items. For example, different levels of a hierarchical taxonomy may specify different combinations of attributes of items, such that items in lower levels of the hierarchical taxonomy share a greater number of attributes, corresponding to greater specificity in an item category, while items in higher levels of the hierarchical taxonomy share a fewer number of attributes, corresponding to less specificity in an item category. In this example, higher levels of the hierarchical taxonomy may include a greater number of items satisfying a broader item category, while lower levels of the hierarchical taxonomy may include a fewer number of items satisfying a more specific item category. The data collection module 200 may collect item data from a source computing system 120, a picker client device 110, or a user client device 100.

The data collection module 200 also collects picker data, which is information or data describing characteristics of pickers. For example, the picker data for a picker may include the picker's name, the picker's location, how often the picker has serviced orders for the online system 140, a user rating for the picker, the source locations from which the picker has collected items, or the picker's previous shopping history. Additionally, the picker data may include preferences expressed by the picker, such as their preferred source locations for collecting items, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data describing characteristics of an order. For example, order data may include item data for items that are included in an order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data include user data for users associated with the order, such as user data for a user who placed the order or picker data for a picker who serviced the order.

While user data, picker data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. In this example, the content presentation module 210 displays the items with scores that exceed some threshold (e.g., the top n items or the p percentile of items). The content presentation module 210 may present items or other types of content (e.g., advertisements, recipes, images, videos, social media posts, etc.) in a portion of a website associated with the online system 140, such as a set of search results, a presentation unit (e.g., a carousel), etc.

The content presentation module 210 may use an item selection model to score items for presentation to a user. An item selection model is a machine-learning model that is trained to score items for a user based on item data for the items and user data for the user. For example, the item selection model may be trained to determine a likelihood that a user will order an item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from user client devices 100 and offers the orders to pickers for service based on picker data. For example, the order management module 220 offers an order to a picker based on the picker's location and the source location from which the ordered items are to be collected. The order management module 220 may also offer an order to a picker based on how many items are in the order, a vehicle operated by the picker, the delivery location, the picker's preferences for how far to travel to deliver an order, the picker's ratings by users, or how often the picker agrees to service an order.

In some embodiments, the order management module 220 determines when to offer an order to a picker based on a delivery timeframe requested by the user who placed the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions indicating how the picker may travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model is used by the machine-learning model to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases in which the training example includes a label, the loss function is also based on the label for the training example. Some examples of loss functions include the mean square error function, the mean absolute error, the hinge loss function, and the cross-entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 retrains the machine-learning model using the additional training data, using any of the methods described above. This deployment and retraining process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

FIG. 3 illustrates an example system architecture for a website evaluation system 150, in accordance with some embodiments. The system architecture illustrated in FIG. 3 includes a website data collection module 300, a model tuning module 310, a sequence generation module 320, a sequence simulation module 330, a response evaluation module 340, and a website data store 350. Alternative embodiments may include more, fewer, or different components from those illustrated in FIG. 3, and the functionality of each component may be divided between the components differently from the description below. Additionally, each component may perform their respective functionalities in response to a request from a human, or automatically without human intervention.

The website data collection module 300 collects data used by the website evaluation system 150 and stores the data in the website data store 350. In preferred embodiments, the website data collection module 300 only collects data describing a user of a website if the user has previously explicitly consented to the website evaluation system 150 collecting data describing the user. Additionally, the website evaluation system 150 may encrypt all data, including sensitive or personal data, describing users.

The website data collection module 300 collects website data, which is information or data that describe characteristics of a website. Website data may include information describing a website, such as a Uniform Resource Locator (URL) for the website, a set of objectives associated with the website, or information describing an entity (e.g., the online system 140 or a source) that is associated with the website. Examples of objectives associated with a website include: increasing a conversion rate, increasing user engagement, improving a user retention rate, improving user experience, etc. In some embodiments, objectives associated with a website may be associated with one or more tasks that may be performed on the website. Examples of such objectives include: presenting distinct items or other types of content in a portion of a website (e.g., a set of search results, a presentation unit, etc.) or presenting items or other types of content that are relevant to a portion of a website in which they are presented (e.g., based on a search query, based on a subject or a theme associated with a presentation unit, etc.). Objectives associated with a website that may be associated with one or more tasks that may be performed on the website may also include presenting items or other types of content that are relevant based on contextual information associated with the website (e.g., based on items in an ordering list) or any other suitable types of objectives.

Website data may also include additional types of information associated with a website. In some embodiments, website data include information describing items available via the website or at one or more source locations operated by a source associated with the website. For example, website data for a website for the online system 140 may include a set of item data for each item included among an inventory of a source location. Website data further may include information describing other types of content (e.g., advertisements, social media posts, games, etc.), services, etc. available via the website. Website data may also include any data collected by an entity associated with the website. In the above example, the website data may also include a set of user data for each user, a set of picker data for each picker, or a set of order data for each order. The website data collection module 300 may collect website data from an entity, such as the online system 140 or a source (e.g., via a source computing system 120) associated with a website, or any other suitable source.

The website data collection module 300 also may collect action data, which is information or data describing actions performed on a website by users of the website. Examples of actions that may be performed on a website include: providing an input into a text box, clicking on a button, hovering over content, scrolling through content, etc. Action data may include information describing a website, an action (e.g., typing, clicking, hovering, scrolling, etc.), an interactive element (e.g., a button, a text field, a scroll bar, etc.), or content (e.g., an item, an image, a video, a link, a set of search results, a presentation unit, etc.) associated with the action. Action data also may include information describing a user who performed an action (e.g., demographic information associated with the user), a type of user client device 100 (e.g., a mobile device) on which the action was performed, a time at which the action was performed, or any other suitable types of information. The website data collection module 300 may collect action data from an entity, such as the online system 140 or a source (e.g., via a source computing system 120) associated with a website, a user client device 100, a picker client device 110, or any other suitable source.

In some embodiments, the action data include feedback associated with a website provided by users of the website. Feedback associated with a website may describe a problem with the website and may be implicit or explicit. For example, if users of a website clicked on lower-ranked search results in a list of search results more frequently than higher-ranked search results in the list of search results, action data may include implicit feedback indicating that more relevant items are ranked lower than higher ranked items. As an additional example, action data may include explicit feedback received via a survey provided to users of a website, in which the feedback describes irrelevant or duplicate search results presented on the website.

In various embodiments, the action data include one or more instructions associated with one or more actions performed on a website. An instruction associated with an action may be associated with a new or updated feature associated with the website. For example, if a new algorithm is used to rank search results on a website, the action data may include instructions associated with any actions performed on the website that may use the new algorithm, such as clicking on or scrolling through search results. An instruction associated with an action may indicate how the action is to be evaluated. For example, an instruction associated with an action may indicate that the action is to be evaluated for a particular problem, for at least a threshold amount of time (e.g., until a conversion rate associated with the action is at least a threshold rate), for users in a particular geographical region to which a new or updated feature was released, etc. An instruction associated with an action may be provided by an entity associated with the website.

Additionally, the website data collection module 300 may collect task data, which is information or data describing tasks performed on a website by users of the website. Examples of tasks that may be performed on a website include: adding an item to an ordering list, searching for an item, browsing items, checking out, or any other suitable types of tasks. Task data may include information describing a sequence of actions corresponding to a task. For example, task data may include information indicating that a task corresponding to searching for an item includes a sequence of actions including typing a search query into a search field and clicking on a button to submit the search query. Task data also may include one or more rules for identifying a sequence of actions corresponding to a task. For example, task data may include a rule indicating that a task corresponding to checking out may include any actions involved in searching for or adding any items present in an ordering list when a checkout page was accessed. The website data collection module 300 may collect task data from an entity, such as the online system 140 or a source (e.g., via a source computing system 120) associated with a website, or any other suitable source.

While website data, action data, and task data are described separately, data collected by the website data collection module 300 may fall into more than one of these categories. For example, data describing a sequence of actions corresponding to a task may be task data and action data.

The model tuning module 310 may tune a generative artificial intelligence (AI) model. The model tuning module 310 may do so by adjusting a set of parameters of an instance of the generative AI model to tailor it to perform a more specific task. Furthermore, the model tuning module 310 may tune the generative AI model based on a set of website data for a website, such as a set of objectives associated with the website, information describing an entity associated with the website, information describing content (e.g., items), services, etc. available via the website or at one or more source locations operated by a source associated with the website, etc. For example, the model tuning module 310 may tune a generative AI model based on a set of website data for a website for the online system 140, which may include a set of objectives associated with the website, information describing a source associated with the website, or item data for one or more items available at one or more source locations operated by the source. In the above example, the set of website data may also include a set of order data for each order, a set of user data for each user, a set of picker data for each picker, etc. The model tuning module 310 may tune the generative AI model via instruction fine-tuning, full fine-tuning, parameter-efficient fine-tuning, transfer learning, task-specific fine-tuning, multi-task learning, sequential fine-tuning, or using any other suitable technique or combination of techniques.

The sequence generation module 320 generates one or more sequences of actions performed on a website. Each sequence of actions may correspond to a task performed on the website by a user of the website. For example, a sequence of actions corresponding to a task of checking out may include the following actions: adding one or more items to an ordering list, clicking on a “View cart” button, and clicking on a “Go to checkout” button. The sequence generation module 320 may generate the sequence(s) of actions based on action data describing actions performed by users of the website and task data associated with tasks corresponding to the sequence(s) of actions received by the website data collection module 300. In some embodiments, a sequence of actions corresponding to a task may be associated with one or more specific items, images, videos, services, etc. For example, a sequence of actions corresponding to a task of searching for an item may include typing a name of a particular item (e.g., “celery”) into a search box and clicking on a “Search” button.

In some embodiments, to generate one or more sequences of actions performed on a website, the sequence generation module 320 first identifies sequences of actions performed on the website by users of the website based on a set of task data describing a task associated with each sequence of actions. For example, suppose that the following actions are performed on a website by a user of the website in the following order: scrolling through items in a carousel of “Best Sellers,” scrolling through items in a carousel of “Fresh Fruit,” typing “strawberries” into a search box, clicking on a “Search” button, clicking on a “Back” button, adding a bunch of grapes to an ordering list, clicking on a “View cart” button, and clicking on a “Go to checkout” button. In this example, based on a set of task data describing a first task corresponding to browsing items, the sequence generation module 320 may generate a first sequence of actions corresponding to the first task, in which the first sequence of actions includes scrolling through the carousel of “Best Sellers” and scrolling through the carousel of “Fresh Fruit.” Continuing with this example, based on a set of task data describing a second task corresponding to searching for an item, the sequence generation module 320 also may generate a second sequence of actions corresponding to the second task, in which the second sequence of actions includes typing “strawberries” into the search box and clicking on the “Search” button. In the above example, based on a set of task data describing a third task corresponding to checking out, the sequence generation module 320 also may generate a third sequence of actions corresponding to the third task, in which the third sequence of actions includes adding the bunch of grapes to the ordering list, clicking on the “View cart” button, and clicking on the “Go to checkout” button.

In embodiments in which the sequence generation module 320 identifies sequences of actions performed on a website by users of the website based on a task associated with each sequence of actions, the sequence generation module 320 also may select one or more of the sequences of actions and generate the selected sequence(s) of actions. The sequence generation module 320 may select the sequence(s) of actions based on various types of information, such as a frequency with which each sequence of actions is performed, a conversion rate associated with each sequence of actions, a set of instructions associated with each sequence of actions, a set of feedback associated with each sequence of actions, or any other suitable types of information. For example, once the sequence generation module 320 identifies sequences of actions performed on a website by users of the website, the sequence generation module 320 may select one or more of the sequences of actions performed during sessions associated with less than a threshold conversion rate (e.g., for adding items to a shopping list, for placing orders, etc.). Alternatively, in the above example, the sequence generation module 320 may generate statistics associated with the sequences of actions and select one or more of the sequences of actions that are performed the most frequently or with at least a threshold frequency. As another alternative, in the above example, the sequence generation module 320 may select one or more of the sequences of actions based on one or more instructions to evaluate one or more actions included in the sequence(s) of actions. As yet another alternative, in the above example, the sequence generation module 320 may select one or more of the sequences of actions based on a set of feedback associated with the sequence(s) of actions received from users of the website describing one or more problems with the website.

The sequence simulation module 330 simulates a performance of a sequence of actions generated by the sequence generation module 320 on a website. For example, if a sequence of actions generated by the sequence generation module 320 corresponds to a task of providing a coupon code in a checkout page, the sequence simulation module 330 may simulate a performance of a sequence of actions corresponding to the task. In this example, if the sequence of actions includes adding three particular items to an ordering list, clicking on a “View cart” button, clicking on a “Go to checkout” button, and typing a particular promotion code (e.g., “10OFF”) into a text field for receiving promotion codes, the sequence simulation module 330 may simulate the performance of the sequence of actions on the website.

When simulating a performance of a sequence of actions generated by the sequence generation module 320 on a website, the sequence simulation module 330 may receive a set of contextual information associated with the website and a response of the website to the sequence of actions. The set of contextual information may be associated with a session during which the performance of the sequence of actions is simulated. Examples of contextual information associated with a website include: information describing a set of items in an ordering list, a current time, a browsing history, a search history, or any other suitable types of contextual information. For example, when simulating a performance of a sequence of actions corresponding to a task of browsing items in a carousel of items recommended based on an item in an ordering list, the sequence simulation module 330 may receive a set of contextual information associated with the website, such as information describing a set of items in the ordering list (e.g., an identifier, a quantity, and a price associated with each item). The response of the website to the sequence of actions may include presenting a set of search results, presenting content in a presentation unit (e.g., a carousel), presenting a checkout page, or any other suitable type of response.

Responsive to receiving a response of a website to simulating a performance of a sequence of actions generated by the sequence generation module 320 on the website, the sequence simulation module 330 may generate information describing the response of the website. The information describing the response of the website may include text, one or more images (e.g., screenshots) or videos, etc. For example, suppose that the sequence simulation module 330 simulates a performance of a sequence of actions corresponding to a task of searching for an item, such that a response of the website includes a set of search results. In this example, upon receiving the response of the website, the sequence simulation module 330 may generate a text file describing the set of search results (e.g., a list of item identifiers for a set of items included among the set of search results). Alternatively, in this example, upon receiving the response of the website, the sequence simulation module 330 may generate information describing the response by capturing one or more screenshots of a user interface of the website. The information describing the response of the website may be generated during one or more key points of a task corresponding to the sequence of actions. In some embodiments, a key point of the task is associated with an action associated with the task, such as adding an item to an ordering list, clicking on an item, receiving a set of search results, browsing a set of items, placing an order, etc. In the above example, the screenshot(s) may be captured during one or more key points of the task, such as when a search query is submitted and when the set of search results is presented.

The response evaluation module 340 evaluates a response of a website to a performance of a sequence of actions on the website simulated by the sequence simulation module 330. The response evaluation module 340 may evaluate the response of the website to identify a set of problems with the website based on a set of contextual information associated with the website, a set of website data for the website, or any other suitable types of information. For example, suppose that the response evaluation module 340 evaluates a response of a website for the online system 140 to a performance of a sequence of actions on the website simulated by the sequence simulation module 330. In this example, the response evaluation module 340 may evaluate the response of the website for a set of problems based on a set of contextual information associated with the website, such as information describing a set of items in an ordering list during a session when the sequence of actions were simulated. In the above example, the response evaluation module 340 also may evaluate the response of the website for the set of problems based on a set of website data for the website, such as a set of objectives associated with the website, information describing a source associated with the website, or item data for one or more items available at one or more source locations operated by the source. When evaluating the response of the website, the response evaluation module 340 may generate an evaluation of the response. The evaluation may be in the format of a report, a training example (e.g., a negative training example for a machine-learning model), or any other suitable type of format. In some embodiments, the evaluation of the response may be reviewed manually.

In some embodiments, the response evaluation module 340 evaluates a response of a website to a performance of a sequence of actions on the website simulated by the sequence simulation module 330 using a generative artificial intelligence (AI) model. The generative AI model may be a vision language model (VLM), a large language model (LLM), or any other suitable type of generative AI model. In various embodiments, the generative AI model is tuned by the model tuning module 310, as described above. In some embodiments, the response evaluation module 340 evaluates the response of the website to the performance of the sequence of actions on the website using multiple generative AI models. In such embodiments, each generative AI model may be specific to a set of problems that it may identify. For example, a generative AI model may be specific to identifying a set of problems with a website based on a design of a user interface of the website, the content of the website, or a relevance of an item or content to a portion of the website.

To use a generative AI model to evaluate a response of a website to a performance of a sequence of actions on the website simulated by the sequence simulation module 330, the response evaluation module 340 may generate a prompt that it provides to the model to obtain an output. The prompt may include a set of contextual information associated with the website, information describing the sequence of actions, a set of website data for the website (e.g., a set of objectives associated with the website), or information describing the response of the website to the sequence of actions. The prompt also may include a request to evaluate the response of the website to identify a set of problems with the website based on the set of contextual information associated with the website, the set of website data for the website, or any other suitable types of information. In some embodiments, the prompt may describe the set of problems to be identified. For example, the prompt may include a request to evaluate the response of the website to identify problems with the website, in which the problems are based on a design of a user interface of the website, content of the website, or a relevance of a set of search results. The prompt also may include information describing a format of an output of the generative AI model or any other suitable types of information. Examples of a format of the output of the generative AI model include: a report, a training example, or any other suitable type of format. For example, the output of the generative AI model may be in the form of a negative training example for a machine-learning model trained to generate a score indicating a relevance of an item or content to a portion of a website, such as a set of search results, a presentation unit (e.g., a carousel), etc. In embodiments in which the generative AI model is tuned based on the set of website data for the website, the prompt may not include the set of website data for the website.

To illustrate an example of a prompt generated by the response evaluation module 340, suppose that the prompt is to be provided to a generative AI model corresponding to a vision language model (VLM) that is tuned based on a set of website data for a website. Suppose also that the set of website data includes objectives associated with the website, information describing a source associated with the website, and item data for items available at source locations operated by the source, and that the objectives include presenting distinct content in each carousel and presenting content that is relevant based on contextual information associated with the website. In this example, the prompt may include contextual information associated with the website describing a set of items included in an ordering list during a performance of a sequence of actions on the website simulated by the sequence simulation module 330, in which the set of items includes a first sliced bread item. In the above example, the prompt may also describe the sequence of actions, which includes scrolling through items in a carousel, and information describing a response of the website to the sequence of actions in the form of a screenshot of a user interface of the website captured during a key point of a task corresponding to the sequence of actions. In this example, the screenshot may indicate that the carousel was presented because the first sliced bread item was in the ordering list, and that a peanut butter item, a strawberry jam item, a second sliced bread item, and a duplicate of the peanut butter item were included in the carousel. In the above example, the prompt also may include a request to evaluate the response of the website to identify a set of problems with the website based on the contextual information and the objectives associated with the website. In this example, the prompt also may describe a format of an output of the model corresponding to a set of negative training examples for one or more machine-learning models. Continuing with this example, the response evaluation module 340 may then provide the prompt to the generative AI model.

Once the response evaluation module 340 provides a prompt to a generative AI model to obtain an output, it extracts, from the output, an evaluation of a response of a website to a performance of a sequence of actions on the website simulated by the sequence simulation module 330. Continuing with the above example, the evaluation may identify a problem with the website including a failure to present content that is relevant based on contextual information associated with the website since the carousel includes the second sliced bread item, which should not be presented since the first sliced bread item was in the ordering list. In the above example, the evaluation also may identify another problem with the website indicating a failure to present distinct content in each carousel since the carousel includes a duplicate of the peanut butter item. Continuing with this example, the evaluation identifying the problems with the website may be in the format of negative training examples for a machine-learning model trained to score items for presentation to a user (e.g., the item selection model described above).

The following illustrates an additional example of a prompt and an evaluation of a response of a website to a performance of a sequence of actions on the website simulated by the sequence simulation module 330. Suppose that a generative AI model is tuned based on a set of website data for a website for the online system 140, in which the set of website data includes an objective associated with the website of presenting items that are relevant to a portion of the website in which they are presented, information describing a source associated with the website, and item data for items available at source locations operated by the source. In this example, suppose that the generative AI model is also tuned based on order data for orders placed with the online system 140 that include items collected from the source locations. In the above example, the prompt generated by the response evaluation module 340 may describe a sequence of actions, which includes scrolling through items in a carousel, and a response of the website to the sequence of actions in the form of a screenshot of a user interface of the website. In this example, the screenshot may indicate that the carousel includes items that are frequently ordered together, and that a cream cheese item, an eggs item, a tortilla chips item, a ham item, and a canned pumpkin item were included in the carousel. In the above example, the prompt also may include a request to evaluate the response of the website to identify a set of problems with the website based on the objective. Continuing with this example, the response evaluation module 340 may then provide the prompt to the generative AI model and extract, from an output of the model, an evaluation of the response of the website to the sequence of actions. In this example, the evaluation may identify a problem with the website including a failure to present items that are relevant to a portion of the website in which they are presented because the carousel includes items that are not frequently ordered together since they are not typically used in a single recipe or meal.

The following illustrates yet another example of a prompt and an evaluation of a response of a website to a performance of a sequence of actions on the website simulated by the sequence simulation module 330. Suppose that a prompt generated by the response evaluation module 340 describes a sequence of actions, which include typing “Brand A” into a search box and clicking on a “Search” button, and a response of the website to the sequence of actions in the form of a screenshot of a user interface of the website captured during a key point of a task corresponding to the sequence of actions. In this example, the screenshot may indicate that the search query was for “Brand A” and that a set of search results returned based on the search query includes several Brand A items, as well as a Brand B item. Suppose also that the prompt includes a request to evaluate the response of the website to identify a set of problems with the website based on a set of website data for the website. Additionally, suppose that the prompt includes the set of website data for the website, in which the set of website data includes an objective of presenting items that are relevant to a set of search results in which they are presented, information describing a source associated with the website, and item data for items available at source locations operated by the source. Suppose also that the response evaluation module 340 then provides the prompt to a generative AI model to obtain an output and extracts, from the output of the generative AI model, an evaluation of the response of the website to the sequence of actions. In this example, the evaluation may identify a problem with the website including a failure to present items that are relevant to a portion of the website in which they are presented since the set of search results includes the Brand B item that is not related to Brand A.

Once the response evaluation module 340 evaluates a response of a website to a sequence of actions simulated by the sequence simulation module 330, it may communicate an evaluation of the response to the website data collection module 300. The website data collection module 300 may then store the evaluation in the website data store 350. The website data collection module 300 may store the evaluation in association with various types of information, such as a time at which the evaluation was obtained, information describing an entity (e.g., the online system 140 or a source) associated with the website, a format of the evaluation, or any other suitable types of information.

The response evaluation module 340 also or alternatively may communicate an evaluation of a response of a website to a sequence of actions simulated by the sequence simulation module 330 to an entity, such as the online system 140 or a source (e.g., via a source computing system 120) associated with the website. The entity may then improve the website based on the evaluation. For example, if the evaluation is in the form of a report describing unrelated items in a carousel of items that are frequently ordered together, the response evaluation module 340 may communicate the report to an entity associated with a website on which the carousel is presented. In this example, the entity may then update a hierarchical taxonomy of items available via the website based on the report. Alternatively, in the above example, if the evaluation is in the form of a set of negative training examples for a machine-learning model trained to generate a score indicating a relevance of content to the carousel, the response evaluation module 340 may communicate the set of negative training examples to the entity, which may then retrain the machine-learning model based on the set of negative training examples.

The website data store 350 stores data used by the website evaluation system 150. For example, the website data store 350 stores website data, action data, and task data for use by the website evaluation system 150. The website data store 350 also may store one or more tuned generative artificial intelligence (AI) models tuned by the model tuning module 310. For example, the website data store 350 may store a set of parameters for a tuned generative AI model on one or more non-transitory, computer-readable media. The website data store 350 uses computer-readable media to store data, and may use databases to organize the stored data.

### Evaluating a Response of a Website to Simulated User Actions Using Artificial Intelligence

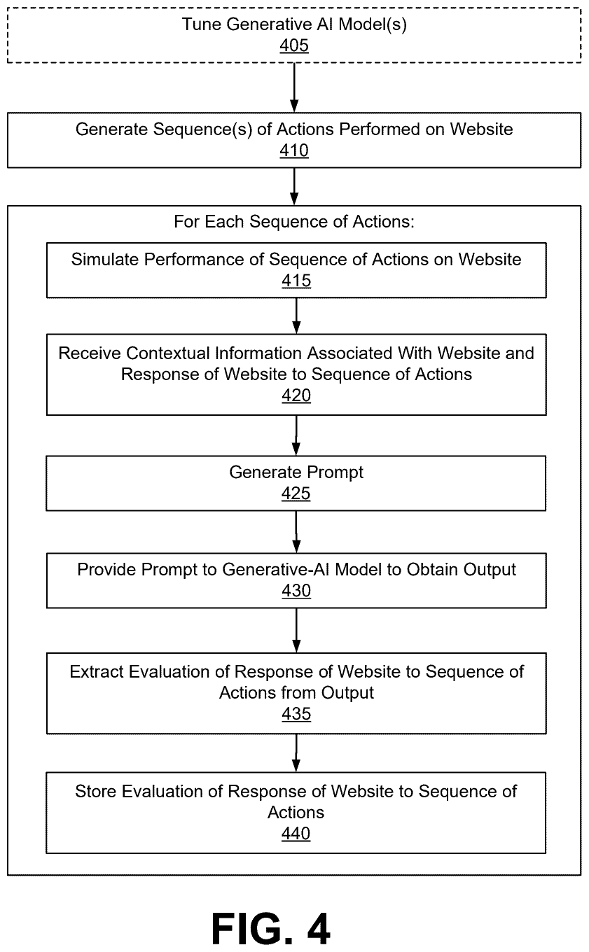

FIG. 4 is a flowchart for a method of evaluating a response of a website to simulated user actions using artificial intelligence, in accordance with some embodiments. Alternative embodiments may include more, fewer, or different steps from those illustrated in FIG. 4, and the steps may be performed in a different order from that illustrated in FIG. 4. These steps may be performed by a website evaluation system (e.g., website evaluation system 150). Additionally, each of these steps may be performed automatically by the website evaluation system without human intervention.

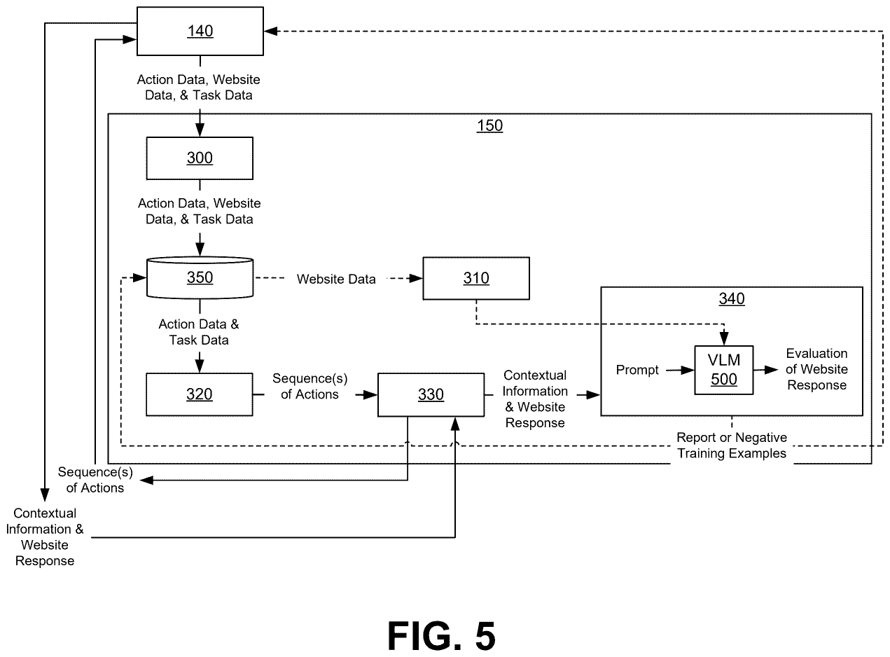

In some embodiments, the website evaluation system 150 tunes 405 (e.g., using the model tuning module 310) one or more generative artificial intelligence (AI) models. The generative AI model(s) may include one or more vision language models (VLMs), one or more large language models (LLMs), or any other suitable type of generative AI model or models. The website evaluation system 150 may tune 405 a generative AI model by adjusting a set of parameters of an instance of the model to tailor it to perform a more specific task. Furthermore, as shown in the example of FIG. 5, which is a process flow diagram for evaluating a response of a website to simulated user actions using artificial intelligence, in accordance with one or more embodiments, the website evaluation system 150 may tune 405 a generative AI model based on a set of website data for a website for the online system 140. The set of website data may include a set of objectives associated with the website, information describing an entity associated with the website, information describing content (e.g., items), services, etc. available via the website or at one or more source locations operated by a source associated with the website, etc. The website evaluation system 150 may tune 405 a generative AI model via instruction fine-tuning, full fine-tuning, parameter-efficient fine-tuning, transfer learning, task-specific fine-tuning, multi-task learning, sequential fine-tuning, or using any other suitable technique or combination of techniques.

Referring back to FIG. 4, the website evaluation system 150 then generates 410 (e.g., using the sequence generation module 320) one or more sequences of actions performed on the website. Each sequence of actions may correspond to a task performed on the website by a user of the website. The website evaluation system 150 may generate 410 the sequence(s) of actions based on action data describing actions performed by users of the website and task data associated with tasks corresponding to the sequence(s) of actions received by the website evaluation system 150 (e.g., via the website data collection module 300), as shown in FIG. 5. In some embodiments, a sequence of actions corresponding to a task may be associated with one or more specific items, images, videos, services, etc. In various embodiments, to generate 410 the sequence(s) of actions, the website evaluation system 150 first identifies (e.g., using the sequence generation module 320) sequences of actions performed on the website by users of the website based on a set of task data describing a task associated with each sequence of actions. In such embodiments, the website evaluation system 150 may then select (e.g., using the sequence generation module 320) the sequence(s) of actions and generate 410 the selected sequence(s) of actions. The website evaluation system 150 may select the sequence(s) of actions based on various types of information, such as a frequency with which each sequence of actions is performed, a conversion rate associated with each sequence of actions, a set of instructions associated with each sequence of actions, a set of feedback associated with each sequence of actions, or any other suitable types of information.

Referring again to FIG. 4, the website evaluation system 150 then simulates 415 (e.g., using the sequence simulation module 330) a performance of each generated sequence of actions on the website. For example, suppose that a sequence of actions generated 410 by the website evaluation system 150 corresponds to a task of searching for an item. In this example, the website evaluation system 150 may simulate 415 the performance of the sequence of actions corresponding to the task (e.g., typing a description of the item into a search box and clicking on a “Search” button) on the website.

When simulating 415 the performance of each sequence of actions on the website, the website evaluation system 150 may receive 420 (e.g., via the sequence simulation module 330) a set of contextual information associated with the website and a response of the website to the sequence of actions, as shown in FIG. 5. The set of contextual information may be associated with a session during which the performance of the sequence of actions is simulated 415. Examples of contextual information associated with the website include: information describing a set of items in an ordering list, a current time, a browsing history, a search history, or any other suitable types of contextual information. The response of the website to the sequence of actions may include presenting a set of search results, presenting content in a presentation unit (e.g., a carousel), presenting a checkout page, or any other suitable type of response.

Responsive to receiving 420 the response of the website to simulating 415 the performance of each sequence of actions, the website evaluation system 150 may generate (e.g., using the sequence simulation module 330) information describing the response of the website. The information describing the response of the website may include text, one or more images (e.g., screenshots) or videos, etc. The information describing the response of the website may be generated during one or more key points of a task corresponding to the sequence of actions. In some embodiments, a key point of the task is associated with an action associated with the task, such as adding an item to an ordering list, clicking on an item, receiving a set of search results, browsing a set of items, placing an order, etc.

The website evaluation system 150 then evaluates (e.g., using the response evaluation module 340) the response of the website to the performance of each sequence of actions on the website simulated 415 by the website evaluation system 150. The website evaluation system 150 may evaluate the response of the website to identify a set of problems with the website based on the set of contextual information associated with the website, the set of website data for the website, or any other suitable types of information. When evaluating the response of the website, the website evaluation system 150 may generate (e.g., using the response evaluation module 340) an evaluation of the response. The evaluation may be in the format of a report, a training example (e.g., a negative training example for a machine-learning model), or any other suitable type of format. In some embodiments, the evaluation of the response may be reviewed manually.

In some embodiments, the website evaluation system 150 evaluates the response of the website to the performance of each sequence of actions on the website simulated 415 by the website evaluation system 150 using the generative AI model(s). In various embodiments, the generative AI model(s) is/are tuned 405 by the website evaluation system 150, as described above. In embodiments in which the website evaluation system 150 evaluates the response of the website to the performance of the sequence(s) of actions on the website using multiple generative AI models, each generative AI model may be specific to a set of problems that it may identify (e.g., based on a design of a user interface of the website, the content of the website, or a relevance of an item or content to a portion of the website).

Referring back to FIG. 4, to use a generative AI model to evaluate the response of the website to the performance of each sequence of actions on the website simulated 415 by the website evaluation system 150, the website evaluation system 150 may generate 425 (e.g., using the response evaluation module 340) a prompt that it provides 430 (e.g., using the response evaluation module 340) to the model to obtain an output. The prompt may include the set of contextual information associated with the website, information describing the sequence of actions, the set of website data for the website (e.g., the set of objectives associated with the website), or the information describing the response of the website to the sequence of actions. The prompt also may include a request to evaluate the response of the website to identify a set of problems with the website based on the set of contextual information associated with the website, the set of website data for the website, or any other suitable types of information. In some embodiments, the prompt may describe the set of problems to be identified. The prompt also may include information describing a format of an output of the generative AI model or any other suitable types of information. Examples of a format of the output of the generative AI model include: a report, a training example, or any other suitable type of format. In embodiments in which the generative AI model is tuned 405 based on the set of website data for the website, the prompt may not include the set of website data for the website.

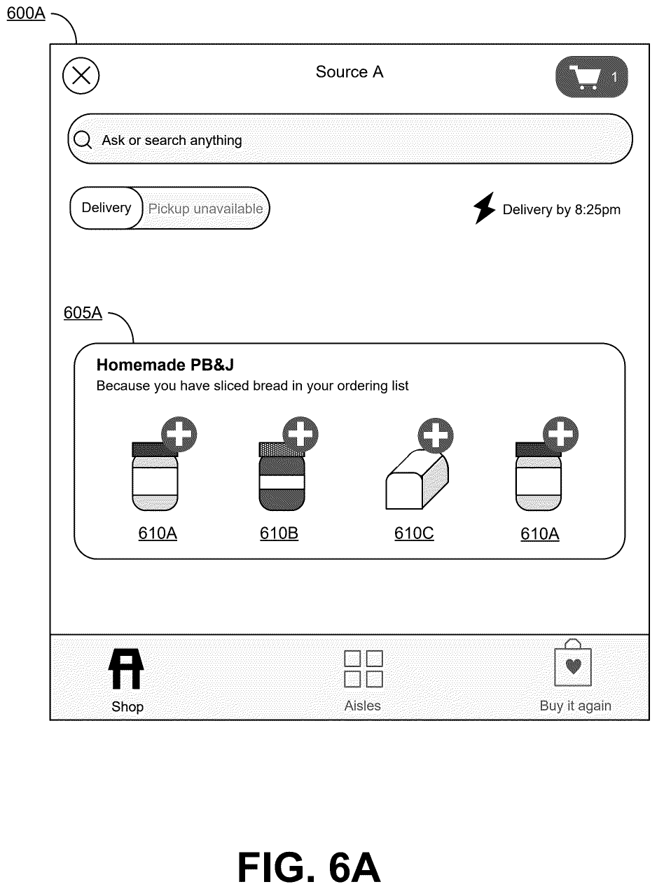

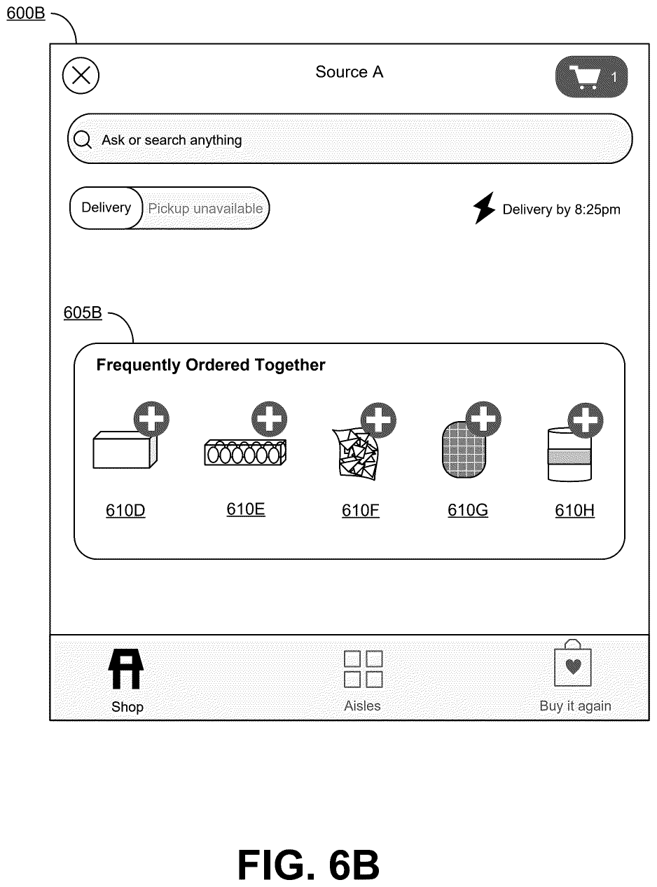

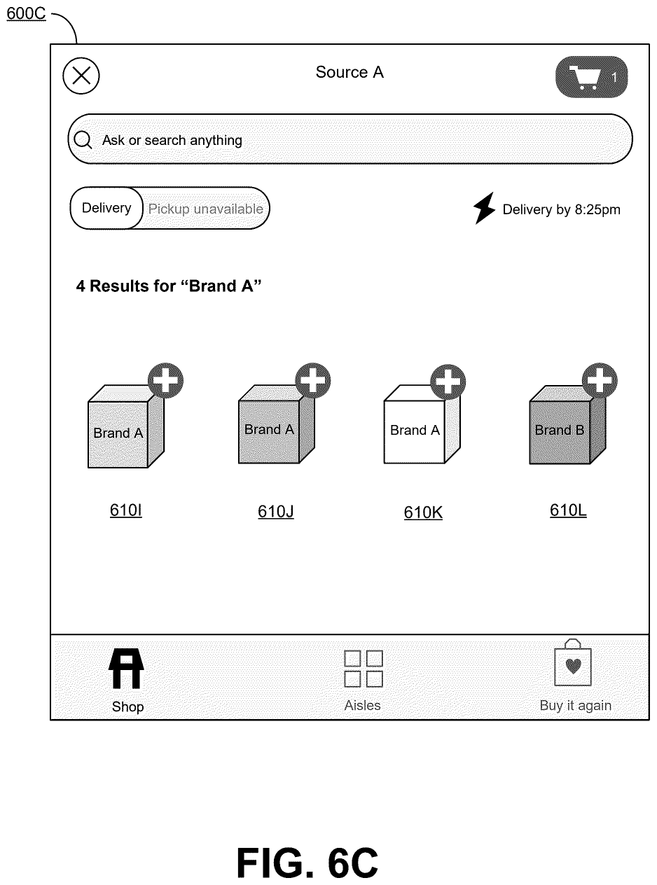

To illustrate an example of a prompt generated 425 by the website evaluation system 150, suppose that the prompt is to be provided 430 to a generative AI model corresponding to a vision language model (VLM) 500 that is tuned 405 based on the set of website data for the website, as shown in FIG. 5. Suppose also that the set of website data includes objectives associated with the website, information describing a source associated with the website, and item data for items available at source locations operated by the source and that the objectives include presenting distinct content in each carousel and presenting content that is relevant based on contextual information associated with the website. In this example, the prompt may include contextual information associated with the website describing a first sliced bread item included in an ordering list during a performance of a sequence of actions on the website simulated 415 by the website evaluation system 150. In the above example, the prompt also may describe the sequence of actions, which includes scrolling through items in a carousel, and information describing the response of the website to the sequence of actions in the form of a screenshot of a user interface of the website captured during a key point of a task corresponding to the sequence of actions. As shown in FIG. 6A, which illustrates an example of a screenshot 600A describing a response of a website to a sequence of actions simulated on the website, in accordance with one or more embodiments, the screenshot 600A may indicate that the carousel 605A was presented because the first sliced bread item was in the ordering list. In this example, the screenshot 600A also may indicate that a peanut butter item 610A, a strawberry jam item 610B, a second sliced bread item 610C, and a duplicate of the peanut butter item 610A were included in the carousel 605A. In the above example, the prompt also may include a request to evaluate the response of the website to identify a set of problems with the website based on the contextual information and the objectives associated with the website. Continuing with this example, the website evaluation system 150 may then provide 430 the prompt to the generative AI model.

Referring again to FIG. 4, once the website evaluation system 150 provides 430 a prompt to a generative AI model to obtain an output, it extracts 435 (e.g., using the response evaluation module 340), from the output, an evaluation of the response of the website to the performance of a sequence of actions on the website simulated 415 by the website evaluation system 150. Continuing with the example described above in conjunction with FIG. 6A, the evaluation may identify a problem with the website including a failure to present content that is relevant based on contextual information associated with the website since the carousel 605A includes the second sliced bread item 610C, which should not be presented since the first sliced bread item 610 was in the ordering list. In the above example, the evaluation also may identify another problem with the website indicating a failure to present distinct content in each carousel 605 since the carousel 605A includes a duplicate of the peanut butter item 610A.

The following illustrates an additional example of a prompt and an evaluation of the response of the website. Suppose that a generative AI model is tuned 405 based on the set of website data for the website, in which the set of website data includes an objective associated with the website of presenting items 610 that are relevant to a portion of the website in which they are presented, information describing a source associated with the website, and item data for items 610 available at source locations operated by the source. Suppose also that the generative AI model is tuned 405 based on order data for orders placed with the online system 140 that include items 610 collected from the source locations. In the above example, the prompt may describe a sequence of actions, which includes scrolling through items 610 in a carousel 605, and the response of the website to the sequence of actions in the form of a screenshot 600 of the user interface of the website. As shown in FIG. 6B, which illustrates an example of a screenshot 600B describing a response of a website to a sequence of actions simulated on the website, in accordance with one or more embodiments, the screenshot 600B may indicate that the carousel 605B includes items 610 that are frequently ordered together and that a cream cheese item 610D, an eggs item 610E, a tortilla chips item 610F, a ham item 610G, and a canned pumpkin item 610H were included in the carousel 605B. In the above example, the prompt also may include a request to evaluate the response of the website to identify a set of problems with the website based on the objective. Continuing with this example, the website evaluation system 150 may then provide 430 the prompt to the generative AI model and extract 435, from an output of the model, an evaluation of the response. In this example, the evaluation may identify a problem with the website including a failure to present items 610 that are relevant to a portion of the website in which they are presented because the carousel 605B includes items 610D-H that are not frequently ordered together since they are not typically used in a single recipe or meal.

The following illustrates yet another example of a prompt and an evaluation of the response of the website. Suppose that a prompt generated 425 by the website evaluation system 150 describes a sequence of actions, which include typing “Brand A” into a search box and clicking on a “Search” button, and the response of the website to the sequence of actions in the form of a screenshot 600 of a user interface of the website captured during a key point of a task corresponding to the sequence of actions. As shown in FIG. 6C, which illustrates an example of a screenshot 600C describing a response of a website to a sequence of actions simulated on the website, in accordance with one or more embodiments, the screenshot 600C may indicate that the search query was for “Brand A” and that a set of search results returned based on the search query includes several Brand A items 610I-K, as well as a Brand B item 610L. Suppose also that the prompt includes a request to evaluate the response of the website to identify a set of problems with the website based on a set of website data for the website, as well as information describing a format of an output corresponding to a set of negative training examples for a machine-learning model. Additionally, suppose that the prompt includes the set of website data for the website, which includes an objective of presenting items 610 that are relevant to a set of search results in which they are presented, information describing a source associated with the website, and item data for items 610 available at source locations operated by the source. Suppose that the website evaluation system 150 then provides 430 the prompt to the generative AI model to obtain an output and extracts 435, from the output of the generative AI model, an evaluation of the response of the website to the sequence of actions. In this example, the evaluation may identify a problem with the website including a failure to present items 610 that are relevant to a portion of the website in which they are presented since the set of search results includes the Brand B item 610L that is not related to Brand A. Furthermore, in this example, the evaluation may be in the format of a negative training example for a machine-learning model trained to score items for presentation to a user (e.g., the item selection model described above).

Referring once more to FIG. 4, once the website evaluation system 150 evaluates the response of the website to each sequence of actions simulated 415 by the website evaluation system 150, it may store 440 (e.g., using the website data collection module 300) the evaluation (e.g., in the website data store 350). The website evaluation system 150 may store 440 the evaluation in association with various types of information, such as a time at which the evaluation was obtained, information describing an entity (e.g., the online system 140 or a source) associated with the website, a format of the evaluation, or any other suitable types of information.

The website evaluation system 150 also or alternatively may communicate (e.g., using the response evaluation module 340) the evaluation of the response of the website to each sequence of actions simulated 415 by the website evaluation system 150 to an entity, such as the online system 140 (as shown in FIG. 5), or a source (e.g., via a source computing system 120) associated with the website. The entity may then improve the website based on the evaluation. For example, if the evaluation is in the form of a report describing unrelated items 610 in a carousel 605 of items 610 that are frequently ordered together, the website evaluation system 150 may communicate the report to an entity associated with the website on which the carousel 605 is presented. In this example, the entity may then update a hierarchical taxonomy of items 610 available via the website based on the report. Alternatively, in the above example, if the evaluation is in the form of a set of negative training examples for a machine-learning model trained to generate a score indicating a relevance of an item 610 to the carousel 605, the website evaluation system 150 may communicate the set of negative training examples to the entity, which may then retrain the machine-learning model based on the set of negative training examples.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
generating, at a website evaluation system, a sequence of actions performed on a website based at least in part on a plurality of actions performed by one or more users of the website, wherein the sequence of actions corresponds to a task performed by the one or more users of the website;
simulating a performance of the sequence of actions on the website;
receiving a set of contextual information associated with the website and a response of the website to the sequence of actions;
generating a prompt comprising:
the set of contextual information associated with the website,
information describing the sequence of actions,
information describing the response of the website to the sequence of actions, and
a request to evaluate the response of the website to the sequence of actions to identify a set of problems with the website based at least in part on the set of contextual information associated with the website and a set of objectives associated with the website;
providing the prompt to a generative artificial intelligence model to obtain an output;
extracting, from the output of the generative artificial intelligence model, an evaluation of the response of the website to the sequence of actions; and
outputting a report that contains the evaluation of the response of the website to the sequence of actions.

2. The method of claim 1, wherein generating the sequence of actions performed on the website based at least in part on the plurality of actions performed by the one or more users of the website comprises:
receiving information describing the plurality of actions performed by the one or more users of the website;
identifying, from the plurality of actions, a plurality of sequences of actions based at least in part on a task associated with each sequence of actions of the plurality of sequences of actions;
selecting the sequence of actions performed on the website based at least in part on one or more of: a frequency with which the sequence of actions is performed on the website, a conversion rate associated with the sequence of actions, a set of instructions associated with the sequence of actions, or a set of feedback associated with the sequence of actions; and
generating the selected sequence of actions performed on the website.

3. The method of claim 1, further comprising:
responsive to receiving the set of contextual information associated with the website and the response of the website to the sequence of actions, generating information describing the response of the website to the sequence of actions by capturing one or more images of a user interface of the website describing the response of the website to the sequence of actions, wherein the one or more images are captured during one or more key points of the task corresponding to the sequence of actions and the one or more key points of the task comprise one or more of: adding an item to an ordering list, clicking on an item, receiving a set of search results, browsing a set of items, or placing an order with an online system.

4. The method of claim 1, further comprising:
tuning the generative artificial intelligence model based at least in part on a set of website data for the website, wherein the set of website data comprises one or more of: the set of objectives associated with the website, information describing a source associated with the website, or item data for one or more items available at one or more source locations operated by the source.

5. The method of claim 1, wherein generating the prompt comprising the set of contextual information associated with the website comprises:
generating the prompt comprising one or more of: information describing a set of items included in an ordering list, a current time, a browsing history, or a search history.

6. The method of claim 1, wherein generating the prompt comprising the request to evaluate the response of the website to the sequence of actions to identify the set of problems with the website based at least in part on the set of contextual information associated with the website and the set of objectives associated with the website comprises:
generating the prompt comprising the request to evaluate the response of the website to the sequence of actions to identify the set of problems with the website based at least in part on the set of contextual information associated with the website and the set of objectives associated with the website, wherein the set of objectives comprises one or more of: presenting distinct content in a portion of the website, presenting content that is relevant to a portion of the website in which it is presented, or presenting content that is relevant based on the set of contextual information associated with the website.

7. The method of claim 1, wherein generating the prompt comprising the request to evaluate the response of the website to the sequence of actions to identify the set of problems with the website based at least in part on the set of contextual information associated with the website and the set of objectives associated with the website comprises:
generating the prompt comprising the request to evaluate the response of the website to the sequence of actions to identify the set of problems with the website based on one or more of: a design of a user interface of the website, content of the website, or a relevance of a set of search results.

8. The method of claim 1, wherein generating the prompt comprises:
generating the prompt comprising:
information describing a format of the output, wherein the format describes one or more of: a report or a set of training examples, and
a set of website data for the website, wherein the set of website data comprises one or more of: the set of objectives associated with the website, information describing a source associated with the website, or item data for one or more items available at one or more source locations operated by the source.

9. The method of claim 8, further comprising:
retraining a machine-learning model to generate a score indicating a relevance of content to a portion of the website, wherein the machine-learning model is retrained using the set of training examples.

10. The method of claim 9, wherein retraining the machine-learning model to generate the score indicating the relevance of the content to the portion of the website comprises:
retraining the machine-learning model to generate the score indicating the relevance of the content to one or more of: a set of search results or a presentation unit.

11. A computer program product comprising a non-transitory computer-readable storage medium having instructions encoded thereon that, when executed by a processor, cause the processor to perform steps comprising:
generating, at a website evaluation system, a sequence of actions performed on a website based at least in part on a plurality of actions performed by one or more users of the website, wherein the sequence of actions corresponds to a task performed by the one or more users of the website;
simulating a performance of the sequence of actions on the website;
receiving a set of contextual information associated with the website and a response of the website to the sequence of actions;
generating a prompt comprising:
the set of contextual information associated with the website,
information describing the sequence of actions,
information describing the response of the website to the sequence of actions, and
a request to evaluate the response of the website to the sequence of actions to identify a set of problems with the website based at least in part on the set of contextual information associated with the website and a set of objectives associated with the website;
providing the prompt to a generative artificial intelligence model to obtain an output;
extracting, from the output of the generative artificial intelligence model, an evaluation of the response of the website to the sequence of actions; and
outputting a report that contains the evaluation of the response of the website to the sequence of action.

12. The computer program product of claim 11, wherein generating the sequence of actions performed on the website based at least in part on the plurality of actions performed by the one or more users of the website comprises:
receiving information describing the plurality of actions performed by the one or more users of the website;
identifying, from the plurality of actions, a plurality of sequences of actions based at least in part on a task associated with each sequence of actions of the plurality of sequences of actions;
selecting the sequence of actions performed on the website based at least in part on one or more of: a frequency with which the sequence of actions is performed on the website, a conversion rate associated with the sequence of actions, a set of instructions associated with the sequence of actions, or a set of feedback associated with the sequence of actions; and
generating the selected sequence of actions performed on the website.

13. The computer program product of claim 11, wherein the computer-readable storage medium further has instructions encoded thereon that, when executed by the processor, cause the processor to perform steps comprising:
responsive to receiving the set of contextual information associated with the website and the response of the website to the sequence of actions, generating information describing the response of the website to the sequence of actions by capturing one or more images of a user interface of the website describing the response of the website to the sequence of actions, wherein the one or more images are captured during one or more key points of the task corresponding to the sequence of actions and the one or more key points of the task comprise one or more of: adding an item to an ordering list, clicking on an item, receiving a set of search results, browsing a set of items, or placing an order with an online system.

14. The computer program product of claim 11, wherein the computer-readable storage medium further has instructions encoded thereon that, when executed by the processor, cause the processor to perform steps comprising:
tuning the generative artificial intelligence model based at least in part on a set of website data for the website, wherein the set of website data comprises one or more of: the set of objectives associated with the website, information describing a source associated with the website, or item data for one or more items available at one or more source locations operated by the source.

15. The computer program product of claim 11, wherein generating the prompt comprising the set of contextual information associated with the website comprises:
generating the prompt comprising one or more of: information describing a set of items included in an ordering list, a current time, a browsing history, or a search history.

16. The computer program product of claim 11, wherein generating the prompt comprising the request to evaluate the response of the website to the sequence of actions to identify the set of problems with the website based at least in part on the set of contextual information associated with the website and the set of objectives associated with the website comprises:
generating the prompt comprising the request to evaluate the response of the website to the sequence of actions to identify the set of problems with the website based at least in part on the set of contextual information associated with the website and the set of objectives associated with the website, wherein the set of objectives comprises one or more of: presenting distinct content in a portion of the website, presenting content that is relevant to a portion of the website in which it is presented, or presenting content that is relevant based on the set of contextual information associated with the website.

17. The computer program product of claim 11, wherein generating the prompt comprising the request to evaluate the response of the website to the sequence of actions to identify the set of problems with the website based at least in part on the set of contextual information associated with the website and the set of objectives associated with the website comprises:
generating the prompt comprising the request to evaluate the response of the website to the sequence of actions to identify the set of problems with the website based on one or more of: a design of a user interface of the website, content of the website, or a relevance of a set of search results.

18. The computer program product of claim 11, wherein generating the prompt comprises:
generating the prompt comprising:
information describing a format of the output, wherein the format describes one or more of: a report or a set of training examples, and
a set of website data for the website, wherein the set of website data comprises one or more of: the set of objectives associated with the website, information describing a source associated with the website, or item data for one or more items available at one or more source locations operated by the source.

19. The computer program product of claim 18, wherein the computer-readable storage medium further has instructions encoded thereon that, when executed by the processor, cause the processor to perform steps comprising:
retraining a machine-learning model to generate a score indicating a relevance of content to a portion of the website, wherein the machine-learning model is retrained using the set of training examples.

20. A computer system comprising:
a processor; and
a non-transitory computer-readable storage medium storing instructions that, when executed by the processor, perform actions comprising:
generating, at a website evaluation system, a sequence of actions performed on a website based at least in part on a plurality of actions performed by one or more users of the website, wherein the sequence of actions corresponds to a task performed by the one or more users of the website;
simulating a performance of the sequence of actions on the website;
receiving a set of contextual information associated with the website and a response of the website to the sequence of actions;
generating a prompt comprising:
the set of contextual information associated with the website,
information describing the sequence of actions,
information describing the response of the website to the sequence of actions, and
a request to evaluate the response of the website to the sequence of actions to identify a set of problems with the website based at least in part on the set of contextual information associated with the website and a set of objectives associated with the website;
providing the prompt to a generative artificial intelligence model to obtain an output;
extracting, from the output of the generative artificial intelligence model, an evaluation of the response of the website to the sequence of actions; and
outputting a report that contains the evaluation of the response of the website to the sequence of action.
